(19) United States
(12) Patent Application Publication
(10) Pub. No.: US 2026/0235021 A1
(43) Pub. Date: Aug. 13, 2026

(54) METHOD FOR DESIGNING LARGE-SCALE FRACTURING IN DEEP GEOTHERMAL RESERVOIRS BASED ON WEAK STRUCTURES

(71) Applicant: CHINA UNIVERSITY OF MINING AND TECHNOLOGY, Xuzhou City (CN)

(72) Inventors: Guoqiang FU, Xuzhou City (CN); Zhiyu TAN, Xuzhou City (CN); Fan XIAO, Xuzhou City (CN); Xiaoge WU, Xuzhou City (CN); Anle TIAN, Xuzhou City (CN); Dezhao WANG, Xuzhou City (CN)

(21) Appl. No.: 19/403,897

(22) Filed: Nov. 30, 2025

(30) Foreign Application Priority Data
Feb. 11, 2025 (CN) 202510147652.6

(51) Int. Cl. E21B 43/26

(52) U.S. Cl. CPC E21B 43/26; E21B 2200/20; E21B 2200/22

(57) ABSTRACT

A method for designing large-scale fracturing in deep geothermal reservoirs based on weak structures, including: carrying out delineation and characterization of weak structures in deep geothermal reservoirs to obtain a characterizing large models; based on the characterizing large models, delineating weak structure zones suitable for large-scale fracturing and evaluating their fracturability to obtain delineated areas; based on the delineated areas, predicting the maximum disturbance range and distance of fracturing simulation of weak structures; and based on the fracturability and predicted disturbance range and distance, determining well spacing, designing well locations, deploying well patterns, and selecting fracturing intervals to complete the design of large-scale fracturing in deep geothermal reservoirs.

### CROSS-REFERENCE TO RELATED APPLICATIONS

This application claims priority to Chinese Patent Application No. 202510147652.6, filed on Feb. 11, 2025, the contents of which are hereby incorporated by reference.

### TECHNICAL FIELD

The present disclosure belongs to the technical field of exploration and development of high-temperature geothermal resources, and specifically relates to a method for designing large-scale fracturing in deep geothermal reservoirs based on weak structures.

### BACKGROUND

Deep geothermal reservoirs are an important type of geothermal reservoirs, referring to high-temperature rock masses with a temperature above 150° C. and burial depths greater than 3,500 meters. The exploration and development of deep geothermal resources in China, as well as the research and development of related core technologies, are still in the initial exploration stage. To date, no commercial exploitation has been successfully realized, and no systematic exploration and development technical method suitable for China's geothermal geological conditions has been formed. Although deep geothermal resources have advantages such as large reserves, renewability and environmental friendliness, compared with traditional fossil energy sources such as oil and natural gas, the deep geothermal resources are still regarded as low-value energy sources in terms of output. This means that to obtain thermal energy resources of the same value, a larger volume of high-temperature liquid needs to be extracted from the formation, resulting in higher development costs and technical investment. In other words, for the exploitation of deep geothermal reservoirs, under the existing conditions, the only way is to achieve a breakthrough in large-scale reservoir fracturing simulation and obtain an ideal fracture network structure with a larger volume, so as to successfully realize the commercial exploitation of Enhanced Geothermal Systems (EGS). However, relevant research has not yet made a breakthrough, which has always been the biggest technical problem restricting the large-scale development and utilization of geothermal resources in China. Therefore, it is urgent to establish an automatic method for designing large-scale fracturing in geothermal reservoirs based on weak structures to support systematic exploration, development and utilization of geothermal resources.

### SUMMARY

The disclosure provides a method for designing large-scale fracturing in deep geothermal reservoirs based on weak structures. The method provides an action mechanism of weak structures in large-scale fracturing of deep geothermal reservoirs, select formation weak structure zones where large-scale fracturing may be implemented, and achieve good effects through low-displacement and low-intensity fracturing.

To achieve the above objectives, the present application provides the following technical solution:

A method for designing large-scale fracturing in deep geothermal reservoirs based on weak structures, including the following steps:
carrying out delineation and characterization of the weak structures in deep geothermal reservoirs for large-scale fracturing formation to obtain a characterizing large model. The characterizing large model includes a deep geothermal reservoir porosity-permeability evolution model, a deep geothermal reservoir physical property model, a model for the evolution of mechanical property of deep geothermal reservoirs, a wellbore storage geological model, a site-scale three-dimensional geological model of deep geothermal reservoirs, a multi-scale embedded weak structure geological model and a rock mechanics constitutive model;
based on the characterizing large model, delineating the weak structure zones of the deep geothermal reservoirs large-scale fracturing formation and carrying out fracturability evaluation to obtain delineated areas;
based on the delineated areas, predicting the maximum disturbance range and distance of fracturing within the weak structures in deep geothermal reservoirs for large-scale fracturing formation; and
based on the maximum disturbance range and distance of fracturing within the weak structures in deep geothermal reservoirs for large-scale fracturing formation, determining well spacing, well locations, deploying well patterns and optionally fracturing intervals to complete the design of the large-scale fracturing of deep geothermal reservoirs.

Optionally, in the characterizing large model:
the deep geothermal reservoir porosity-permeability evolution model is used to characterize the distribution of physical properties of geothermal reservoirs at the laboratory scale;
the deep geothermal reservoir physical property model is used to characterize the distribution of physical characteristics of geothermal reservoirs at the laboratory scale under high temperature;
the model for the evolution of mechanical properties of deep geothermal reservoirs with temperature is used to represent the distribution of mechanical characteristics of deep geothermal reservoirs at the laboratory scale under high temperature;
the wellbore storage geological model is used to represent the distribution characteristics of geothermal reservoirs at the wellbore storage scale;
the site-scale three-dimensional geological model of deep geothermal reservoirs is used to analyze and interpret accurate information of formations for large-scale fracturing of deep geothermal reservoirs of different types and scales;
the multi-scale embedded weak structure geological model is used to locate and describe weak structures of different types and scales; and
the rock mechanics constitutive model is used to represent the complex weak structure characteristics of deep geothermal reservoirs.

Optionally, the method for delineation includes: using the characterizing large model to analyze geothermal reservoir parameters, studying a nonlinear evaluation method for deep geothermal reservoirs, evaluate the quality and weakness degree of geothermal reservoirs and completing the delineation of weak structure zones for large-scale fracturing in deep geothermal reservoirs.

Optionally, the method for carrying out fracturability evaluation includes: establishing a mechanical brittleness index model reflecting the whole process characteristics of rock deformation and failure, analyzing the brittleness, activation conditions and expansion modes of geothermal reservoir weak structures, and obtaining the fracturability of weak structures in deep geothermal reservoirs for large-scale fracturing formation according to rock brittleness, development characteristics of weak structures and in-situ stress distribution.

Optionally, based on the characterizing large model and combined with triaxial fracturing experiments, the farthest disturbance range and distance of geothermal reservoir fracturing simulation are predicted and the method further includes: applying the disturbance range, temperature-dependent mechanical parameters, and stress-response characteristics obtained from triaxial experimental data in controlling geothermal fracturing operations, including optimization of well spacing, fracturing intervals, and fluid injection parameters in geothermal reservoirs.

The disclosure also provides a system for designing a large-scale fracturing in deep geothermal reservoirs based on weak structures, the system is used to implement the above method and includes a construction module, a delineation module, a prediction module and a design module;
the construction module is used to carry out delineation and characterization of the weak structures in deep geothermal reservoirs for large-scale fracturing formation to obtain a characterizing large model;
the delineation module is used to characterize the weak structure zones of scale fracturing formation in deep geothermal reservoirs and carry out fracturability evaluation based on the characterizing large model to obtain delineated areas;
the prediction module is used to predict the maximum disturbance range and distance of fracturing simulation of the weak structures in deep geothermal reservoirs for large-scale fracturing formation based on the delineated areas; and
the design module is used to determine well spacing, design well locations, deploy well patterns and select fracturing intervals based on the farthest disturbance range and distance of fracturing simulation of the weak structures in deep geothermal reservoirs for large-scale fracturing formation, so as to complete the design of the large-scale fracturing of deep geothermal reservoirs.

Optionally, the characterizing large model includes a deep geothermal reservoir porosity-permeability evolution model, a deep geothermal reservoir physical property model, a model for the evolution of mechanical properties of deep geothermal reservoirs with temperature, a wellbore storage geological model, a site-scale three-dimensional geological model of deep geothermal reservoirs, a multi-scale embedded weak structure geological model and a rock mechanics constitutive model;
the deep geothermal reservoir porosity-permeability evolution model is used to represent the distribution of physical properties of geothermal reservoirs at the laboratory scale;
the deep geothermal reservoir physical property model is used to represent the distribution of physical characteristics of geothermal reservoirs at the laboratory scale under high temperature;
the model for the evolution of mechanical properties of deep geothermal reservoirs with temperature is used to represent the distribution of mechanical characteristics of deep geothermal reservoirs at the laboratory scale under high temperature;
the wellbore storage geological model is used to represent the distribution characteristics of geothermal reservoirs at the wellbore storage scale;
the site-scale three-dimensional geological model of deep geothermal reservoirs is used to analyze and interpret accurate information of formations for large-scale fracturing of deep geothermal reservoirs of different types and scales;
the multi-scale embedded weak structure geological model is used to locate and describe weak structures of different types and scales;
the rock mechanics constitutive model is used to represent the complex weak structure characteristics of deep geothermal reservoirs.

Advantageous effects of the disclosure are as follows:

By constructing the characterizing large model, the method automatically controls fracturing operations in deep geothermal reservoirs and accurately provide the formation of weak structure zones suitable for fracturing, the maximum disturbance range and distance of fracturing simulation, thereby optimizing well location design, well pattern deployment and selection of fracturing intervals, realizing efficient exploitation under low-displacement and low-intensity fracturing conditions, and provide strong support for the systematic exploration, development and utilization of geothermal reservoir resources.

### BRIEF DELINEATION OF THE DRAWINGS

In order to more clearly illustrate the technical solutions in the embodiments of the disclosure, the drawings required in the embodiments will be briefly introduced below. Obviously, the drawings in the following description are only some embodiments of the disclosure. For those of ordinary skill in the art, other drawings may be obtained according to these drawings without creative work.

FIG. 1 is a flowchart of the method for designing large-scale fracturing in deep geothermal reservoirs based on weak structures of the present disclosure.

FIG. 2 is a flowchart of the specific steps of predicting the maximum disturbance range and distance of fracturing simulation of the weak structures in deep geothermal reservoirs for large-scale fracturing formation based on the delineated areas.

FIG. 3 is a flowchart of the steps of determining well spacing, designing well locations, deploying well patterns and optionally fracturing intervals to complete the design of the large-scale fracturing of geothermal reservoirs based on the farthest disturbance range and distance of fracturing simulation of the weak structures in deep geothermal reservoirs for large-scale fracturing.

FIG. 4 is a schematic diagram of a multi-scale embedded weak structure geological model according to an embodiment of the disclosure.

FIG. 5 is a schematic diagram of a correlation model between geophysical fields and mechanical characteristics of geothermal reservoirs according to an embodiment of the disclosure.

### DETAILED DELINEATION OF THE EMBODIMENTS

The technical solutions in the embodiments of the disclosure will be clearly and completely described below with reference to the drawings in the embodiments of the disclosure. Obviously, the described embodiments are only a part of the embodiments of the disclosure, not all of them. Based on the embodiments of the disclosure, all other embodiments obtained by those of ordinary skill in the art without creative work shall fall within the protection scope of the disclosure.

In order to make the above objectives, features and advantages of the disclosure more obvious and understandable, the disclosure will be further described in detail below with reference to the drawings and specific embodiments.

### Embodiment 1

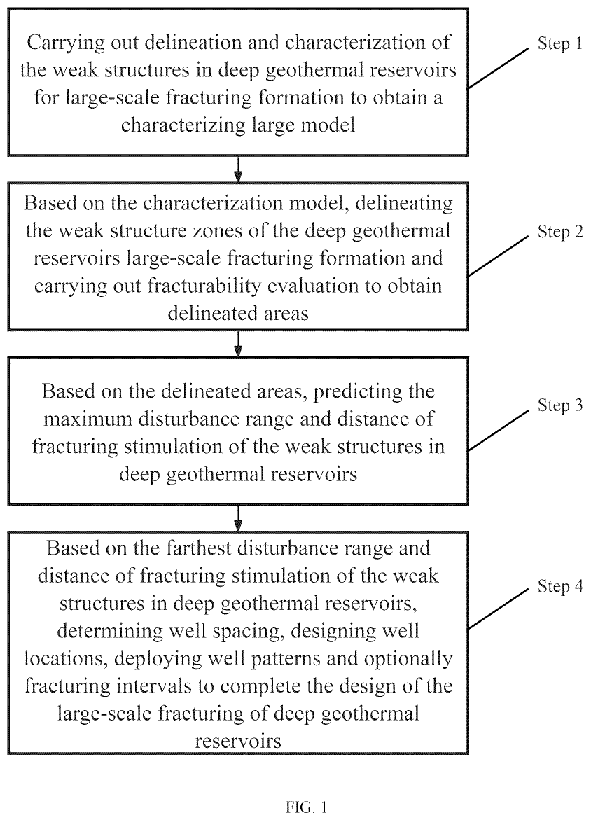

The method for designing a large-scale fracturing in deep geothermal reservoirs based on weak structures of this embodiment includes the following steps (as shown in FIG. 1):
step 1, carrying out delineation and characterization of the weak structures in deep geothermal reservoirs for large-scale fracturing formation to obtain a characterizing large model.

Specifically, in this embodiment, the weak structures in deep geothermal reservoirs for large-scale fracturing formation (hereinafter referred to as weak structures) are simulated in a laboratory, and then carried out delineation and characterization. The characterizing large model includes a deep geothermal reservoir porosity-permeability evolution model, a deep geothermal reservoir physical property model, a model for the evolution of mechanical properties of deep geothermal reservoirs with temperature, a wellbore storage geological model, a multi-scale embedded weak structure geological model and a rock mechanics constitutive model.

Specifically, real-time scanning and triaxial experiments are carried out by high-energy computed tomography (CT), a visualized numerical model of deep geothermal reservoirs is constructed by using three-dimensional reconstruction technology. Combined with high-temperature and high-pressure servo permeability experiments, the visualized numerical model is optimized, and a deep geothermal reservoir porosity-permeability evolution model containing temperature and pressure parameters is constructed. The distribution of physical properties of geothermal reservoirs at the laboratory scale is carried out delineation and characterization by using the deep geothermal reservoir porosity-permeability evolution model. Specifically, by testing the porosity and permeability parameters of deep geothermal reservoirs under different temperature and pressure conditions, the porosity and permeability parameters under different conditions are fitted to obtain the evolution law of porosity and permeability of deep geothermal reservoirs with temperature and pressure parameters.

In the embodiment, the steps of the triaxial experiment include: sealing the sample in a triaxial fracturing system, heating at a fixed rate, keeping the temperature constant, carrying out pressurization according to preset conditions, and then injecting fracturing fluid for fracturing.

The steps of the high-temperature and high-pressure servo permeability experiment include: sealing the sample, placing it in a servo permeability experiment system, heating, keeping the temperature constant, then applying axial load, confining pressure and pore pressure respectively, and forming a permeability pressure difference at both ends of the sample by adjusting the pore pressure control system to complete the permeability experiment of the sample under high-temperature and high-pressure conditions.

Through cross-frequency rock physics experiments, the changes of geothermal reservoirs primary waves and secondary waves velocities, electrical resistivity, magnetism, polarizability, density and elastic parameters of geothermal reservoirs with temperature and pressure are studied, and a deep geothermal reservoir physical characteristic model is established to carry out delineation and characterization of the distribution of physical characteristics of geothermal reservoirs at the laboratory scale under high temperature. Specifically, the steps of the cross-frequency rock physics experiment include: measuring the seismic wave velocity and ultrasonic wave velocity of the sample at different frequencies by using a cross-frequency rock parameter testing system, and calculating various rock parameters.

The deep geothermal reservoir physical characteristic model is essentially established by carrying out cross-frequency rock physics experiments at different temperatures to obtain various parameters such as primary waves and secondary waves velocities, electrical resistivity, magnetism, polarizability, density and elastic parameters under different temperature and pressure conditions, fitting the changes of various parameters with temperature and pressure conditions, corresponding formulas are obtained and combined, and the deep geothermal reservoir physical characteristic model is obtained.

Based on laboratory experiment analysis, and by integrating outcrop, drilling, logging and on-site test data, the structure of wellbore storage media is identified and interpreted, a wellbore storage geological model is established, and the delineation and characterization of the distribution characteristics of geothermal reservoirs at the wellbore storage scale are carried out. Specifically, according to outcrop, drilling, logging, on-site test data, etc., a three-dimensional geological model may be initially constructed, the well location may be confirmed, and a wellbore storage geological model may be established.

Based on rock physical experiments, logging data analysis, forward and inverse simulation, constrained inversion, geophysical structure interpretation, weak structural plane characterization and attribute analysis, etc., detailed structural characteristic information of deep geothermal reservoirs is obtained, and a site-scale three-dimensional geological model of deep geothermal reservoirs is established. The specific steps include:
through rock physics experiments, physical and mechanical parameters of deep geothermal reservoirs such as tensile strength, compressive strength, porosity and permeability may be obtained to provide mechanical parameter support for the model; through logging data, not only thermal parameters of geothermal reservoirs such as thermal conductivity may be obtained, but also the thermal structure of geothermal reservoirs may be calculated comprehensively through various logging parameters; through forward and inverse simulation, constrained inversion, etc., quantitative analysis and calculation may be carried out on the electrical characteristics, gravity and magnetic field characteristics and geothermal field characteristics of geothermal reservoirs, and parameter support is provided for explaining the genetic mechanism of geothermal reservoirs and evaluating resource reserves; through geophysical structure interpretation, weak structural plane characterization, the weak structures of geothermal reservoirs may be positioned with high precision, and the accuracy of the three-dimensional geological model may be improved.

By using the established site-scale three-dimensional geological model of deep geothermal reservoirs, accurate information of weak structures of different types and scales is analyzed and interpreted. The accurate information includes spatial distribution, geometric shape, development density, scale, burial depth, superposition and contact relationship, etc.

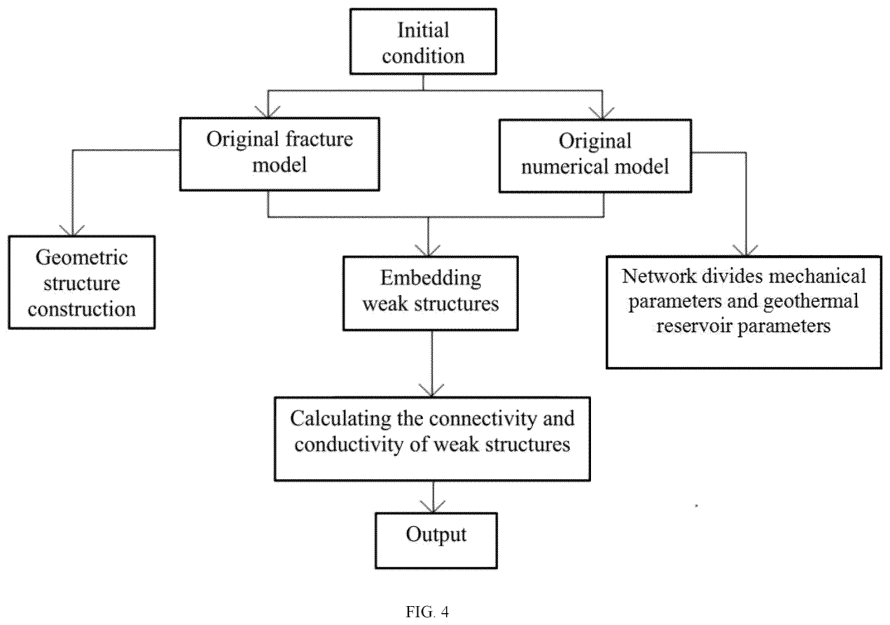

A multi-scale embedded weak structure geological model is constructed by using finite difference, finite element, finite volume method, as shown in FIG. 4. Compared with traditional models, the multi-scale embedded weak structure geological model uses an unstructured grid method to characterize fractures, avoids the cumbersome problem of unstructured grid division in traditional modeling, qualitatively analyzes the distribution of weak structures, and has higher accuracy. In the embodiment, the finite element method is used to construct the multi-scale embedded weak structure geological model. The finite element method is a traditional numerical method, which treats weak structures as the boundaries of grids. The structural matrix displacement method is the early prototype of the finite element method, and later the weighted residual finite element method and the variational principle finite element method are developed. Among them, the Galerkin finite element method is a typical representative of the weighted residual method. Generally, based on the stress equilibrium equation, firstly the displacement field is solved, secondly the strain and stress fields at the Gauss points are calculated, and then the results at the Gauss points are extended to the grid nodes.

For complex weak structure characteristics (fracture type, fracture-pore type, pore type, cavity type, broken type, joint type, etc.), based on the effective medium theory (EMT), a rock mechanics constitutive model of discontinuous geothermal reservoir media under high temperature is established by using the parallel superposition calculation method of pore and matrix strain. Specifically, according to the theory of elasticity, the strain field conforms to the superposition principle, and the superposition principle of the strain field is also used when the rock constitutive model is constructed. The total strain is equal to the sum of strains caused by various stresses. By determining the boundary conditions of various weak structures, the distribution of stress and strain may be confirmed, and the mechanical constitutive model of discontinuous geothermal reservoir media may be constructed by performing parallel superposition calculation on the strains of various weak structures.
Step 2, based on the characterization model, delineating the weak structure zones of the deep geothermal reservoirs large-scale fracturing formation and carrying out fracturability evaluation to obtain delineated areas.

Based on the characterizing large models established in S1, the obtained geothermal reservoir parameters are analyzed, a nonlinear evaluation method for deep geothermal reservoirs is studied, the quality and weakness degree of geothermal reservoirs are evaluated, and the weak structure zones where large-scale fracturing may be implemented under the existing technical conditions are delineated to obtain delineated areas. Where the geothermal reservoir parameters include all the mechanical parameters, thermal parameters, electrical parameters, etc. obtained through laboratory experiments, logging, drilling, on-site tests and forward and inverse simulations.

The steps of the nonlinear evaluation method for deep geothermal reservoirs include: confirming the area, thickness, temperature, porosity, rock density, etc. of geothermal reservoirs through the obtained parameters, calculating the geothermal reserves and recoverable reserves of different intervals of the model in sections, and calculating the productivity according to the recoverable reserves.
Step 3, based on the delineated areas, predicting the maximum disturbance range and distance of fracturing stimulation of the weak structures in deep geothermal reservoirs.

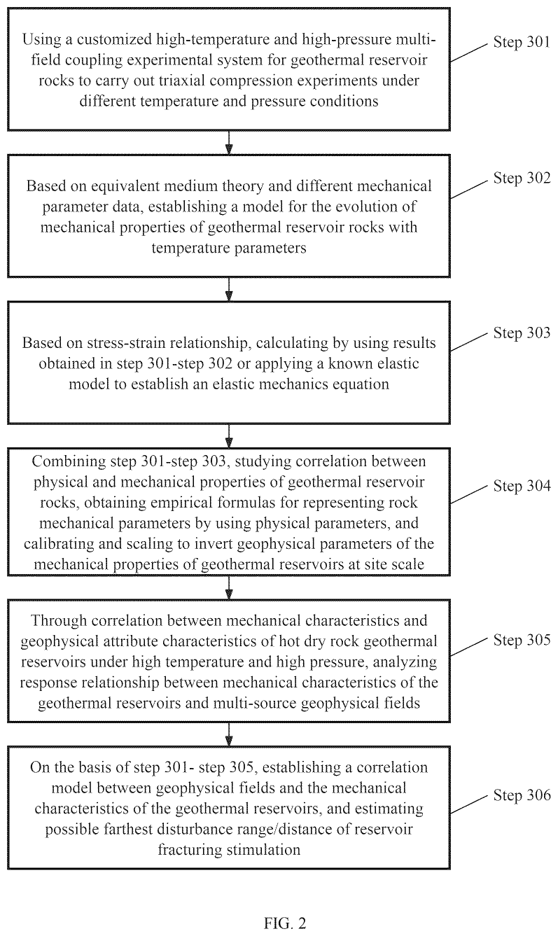

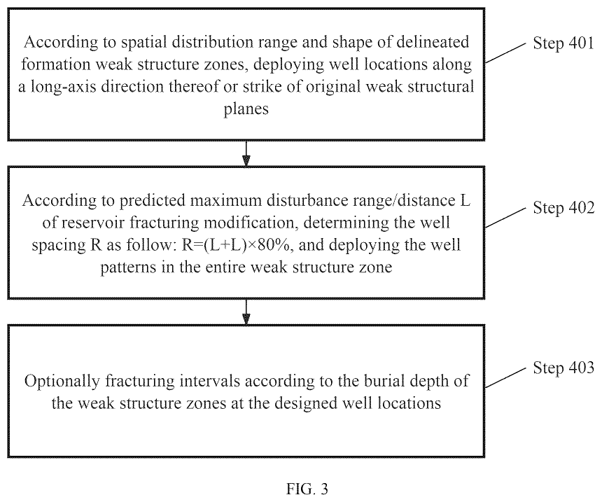

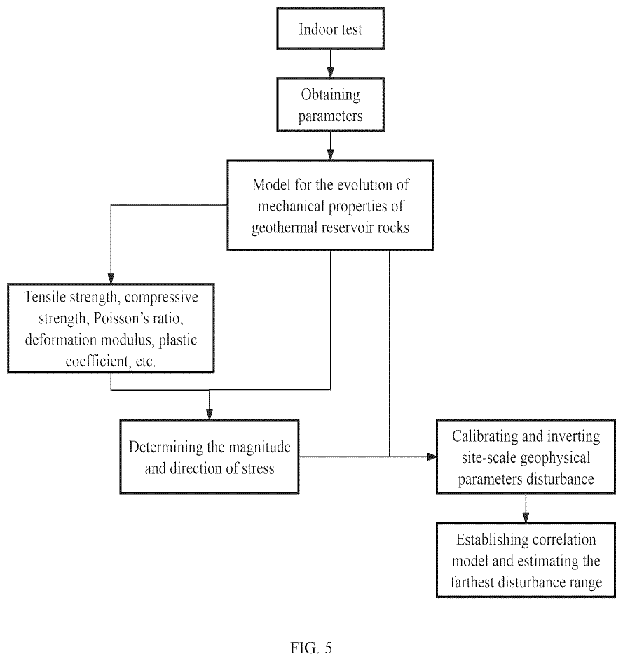

In the delineated areas, combined with triaxial fracturing experiments, the possible farthest disturbance range/distance of geothermal reservoir fracturing simulation is predicted. The specific steps are as follows (as shown in FIG. 2):
step 301, using a customized high-temperature and high-pressure multi-field coupling experimental system for geothermal reservoir rocks to carry out triaxial compression experiments under different temperature and pressure conditions, and simultaneously monitoring acoustic emission, wave velocity and deformation (axial and circumferential). According to the stress-strain, acoustic emission and wave velocity data, the mechanical properties of geothermal reservoir rocks under high-temperature and high-pressure conditions such as triaxial compressive strength, deformation modulus, Poisson's ratio, plastic coefficient, elastic wave velocity and dynamic elastic modulus and their evolution laws are clarified;
step 302, based on the equivalent medium theory and different mechanical parameter data, establishing a model for the evolution of mechanical properties of geothermal reservoir rocks with temperature parameters, and constructing the correlation and constitutive relationship between the mechanical properties of geothermal reservoir rocks under high temperature; the expression of the model for the evolution of mechanical properties of geothermal reservoir rocks containing temperature parameters is as follows:

$$[ {ρ}_{s} {C}_{s} ( 1 - ∅ ) + {ρ}_{1} {C}_{1} ∅ ] \frac{\partial T}{\partial t} + ( T + {T}_{0} ) {K}^{′} {α}_{T} \frac{\partial {ε}_{T}}{\partial t} + {ρ}_{1} {C}_{1} ( T + {T}_{0} ) \frac{k}{μ} ∇ p = {λ}_{M} {∇}^{2} T ,$$

where, T and T₀ represent temperature and initial temperature respectively, K′ represents the bulk modulus of rock, α_{T} represents the thermal expansion coefficient of rock, λ_{M} represents thermal conductivity, t represents time, and εT represents volume strain; ρ₁C₁Ø represents the specific heat capacity of water, ρₛCₛ(1−Ø) represents the specific heat capacity of the rock matrix, [ρₛCₛ(1−Ø)+ρ₁C₁Ø] represents the specific heat capacity of fluid-containing porous media, k represents the permeability of continuous media, μ represents the dynamic viscosity of fluid, ∇ represents the gradient operator, and ∇p represents the pressure gradient;
step 303, based on the stress-strain relationship, calculating by using the results obtained in step 301-step 302 or applying a known elastic model to establish an elastic mechanics equation, solving the stress distribution inside the geothermal reservoir rocks under different temperature and pressure conditions, and determining the magnitude and direction of stress disturbance;
step 304, combining step 301-step 303, studying the correlation between the physical and mechanical properties of geothermal reservoir rocks, obtaining empirical formulas for representing rock mechanical parameters by using physical parameters, and calibrating and scaling to invert the geophysical parameters of the mechanical properties of geothermal reservoirs at the site scale;
step 305, through the correlation between the mechanical characteristics and geophysical attribute characteristics of hot dry rock geothermal reservoirs under high temperature and high pressure, analyzing the response relationship between the mechanical characteristics of geothermal reservoirs and multi-source geophysical fields; and
step 306, on the basis of step 301-step 305, establishing a correlation model between geophysical fields and the mechanical characteristics of geothermal reservoirs (as shown in FIG. 5), and combining with the equivalent medium theory, clarifying the variation law of the mechanical properties of geothermal reservoirs with temperature at the site scale, and estimating the possible farthest disturbance range/distance of reservoir fracturing simulation.
Step 4, based on the farthest disturbance range and distance of fracturing stimulation of the weak structures in deep geothermal reservoirs, determining well spacing, designing well locations, deploying well patterns and optionally fracturing intervals to complete the design of the large-scale fracturing of deep geothermal reservoirs (as shown in FIG. 3). In certain embodiments, the design outputs including the well spacing, fracturing intervals, and stimulation parameters are transmitted to the fracturing control system. The control system regulates fluid injection rate, injection pressure, and pumping sequence to physically execute the fracturing operations in the deep geothermal reservoirs.
Step 401, according to the spatial distribution range and shape of the delineated formation weak structure zones, deploying well locations along the long-axis direction thereof or the strike of the original weak structural planes;
step 402, according to the predicted or estimated possible maximum disturbance range/distance L of reservoir fracturing simulation, considering the uncertainty of estimation accuracy and the objective requirement of easy connectivity between wells, setting a 20% overlapping section of the disturbance ranges between two adjacent wells, then the well spacing R may be determined as:

$$R = ( L + L ) \times 80 \%$$

and deploying well patterns in the entire weak structure zone;
step 403, fracturing intervals according to the burial depth of the weak structure zones at the designed well locations, and the method further includes: applying the disturbance range, temperature-dependent mechanical parameters, and stress-response characteristics obtained from triaxial experimental data in controlling geothermal fracturing operations, including optimization of well spacing, fracturing intervals, and fluid injection parameters in deep geothermal reservoirs.

### Embodiment 2

This embodiment also provides a system for designing a large-scale fracturing of deep geothermal reservoirs based on weak structures, including a construction module, a delineation module, a prediction module and a design module; the construction module is used to characterize and represent the weak structures in deep geothermal reservoirs for large-scale fracturing to obtain a characterizing large models; the delineation module is used to delineate the weak structure zones of the formation for large-scale fracturing of deep geothermal reservoirs and carry out fracturability evaluation based on the characterizing large models to obtain delineated areas; the prediction module is used to predict the farthest disturbance range and distance of fracturing simulation of the weak structures in deep geothermal reservoirs for large-scale fracturing based on the delineated areas; the design module is used to determine well spacing, design well locations, deploy well patterns and select fracturing intervals based on the farthest disturbance range and distance of fracturing simulation of the weak structures in deep geothermal reservoirs for large-scale fracturing, so as to complete the design of the large-scale fracturing of deep geothermal reservoirs.

The above-mentioned characterizing large models includes a deep geothermal reservoir porosity-permeability evolution model, a deep geothermal reservoir physical property model, a model for the evolution of mechanical properties of deep geothermal reservoirs with temperature, a wellbore storage geological model, a site-scale three-dimensional geological model of deep geothermal reservoirs, a multi-scale embedded weak structure geological model and a rock mechanics constitutive model; the deep geothermal reservoir porosity-permeability evolution model is used to represent the distribution of physical properties of geothermal reservoirs at the laboratory scale; the deep geothermal reservoir physical property model is used to represent the distribution of physical characteristics of geothermal reservoirs at the laboratory scale under high temperature; the model for the evolution of mechanical properties of deep geothermal reservoirs with temperature is used to represent the distribution of mechanical characteristics of deep geothermal reservoirs at the laboratory scale under high temperature; the wellbore storage geological model is used to represent the distribution characteristics of geothermal reservoirs at the wellbore storage scale; the site-scale three-dimensional geological model of deep geothermal reservoirs is used to analyze and interpret accurate information of formations for large-scale fracturing of deep geothermal reservoirs of different types and scales; the multi-scale embedded weak structure geological model is used to locate and describe weak structures of different types and scales; the rock mechanics constitutive model is used to represent the complex weak structure characteristics of deep geothermal reservoirs.

The above-mentioned embodiments are only delineations of the preferred modes of the disclosure, and are not intended to limit the scope of the disclosure. Without departing from the design spirit of the disclosure, various simulations and improvements made by those of ordinary skill in the art to the technical schemes of the disclosure shall fall within the protection scope defined by the claims of the disclosure.

What is claimed is:

1. A method for designing large-scale fracturing construction scheme in deep geothermal reservoirs based on weak structures, comprising following steps:
carrying out delineation and characterization of the weak structures in deep geothermal reservoirs for large-scale fracturing to obtain a comprehensive characterizing large models; wherein the comprehensive characterizing large models comprises a deep geothermal reservoir porosity-permeability evolution model, a deep geothermal reservoir physical property model, a model for the evolution of mechanical properties of deep geothermal reservoirs with temperature, a wellbore storage geological model, a site-scale three-dimensional geological model of deep geothermal reservoirs, a multi-scale embedded weak structure geological model and a rock mechanics constitutive model;
based on the comprehensive characterizing large models, delineating the weak structure zones in the deep geothermal reservoirs for large-scale fracturing and carrying out fracturability evaluation to obtain delineated areas;
based on the delineated areas and combined with triaxial fracturing experiments, predicting the farthest disturbance range and distance of fracturing stimulation of the weak structures in deep geothermal reservoirs; wherein the step comprises following steps:
step 301, using a customized high-temperature and high-pressure multi-field coupling experimental system for geothermal reservoir rocks to carry out triaxial compression experiments under different temperature and pressure conditions;
step 302, based on equivalent medium theory and different mechanical parameter data, establishing a model for the evolution of mechanical properties of geothermal reservoir rocks with temperature parameters;
$$[ {ρ}_{s} {C}_{s} ( 1 - ∅ ) + {ρ}_{1} {C}_{1} ∅ ] \frac{\partial T}{\partial t} + ( T + {T}_{0} ) {K}^{′} {α}_{T} \frac{\partial {ε}_{T}}{\partial t} + {ρ}_{1} {C}_{1} ( T + {T}_{0} ) \frac{k}{μ} ∇ p = {λ}_{M} {∇}^{2} T ,$$
wherein T and T₀ represent temperature and initial temperature respectively, K′ represents bulk modulus of rock, α_{T} represents a thermal expansion coefficient of rock, λ_{M} represents thermal conductivity, t represents time, and εT represents volume strain; ρ₁C₁Ø represents specific heat capacity of water, ρₛCₛ(1−Ø) represents specific heat capacity of rock matrix, [ρₛCₛ(1−Ø)+ρ₁C₁Ø] represents specific heat capacity of fluid-containing porous media, k represents permeability of continuous media, μ represents dynamic viscosity of fluid, ∇ represents gradient operator, and ∇p represents pressure gradient;
step 303, based on stress-strain relationship, calculating by using results obtained in step 301-step 302 or applying a known elastic model to establish an elastic mechanics equation;
step 304, combining step 301-step 303, studying correlation between physical and mechanical properties of geothermal reservoir rocks, obtaining empirical formulas for representing rock mechanical parameters by using physical parameters, and calibrating and scaling to invert geophysical parameters of the mechanical properties of geothermal reservoirs at site scale;
step 305, through correlation between mechanical characteristics and geophysical attribute characteristics of hot dry rock geothermal reservoirs under high temperature and high pressure, analyzing response relationship between mechanical characteristics of the geothermal reservoirs and multi-source geophysical fields;
step 306, on the basis of step 301-step 305, establishing a correlation model between geophysical fields and the mechanical characteristics of the geothermal reservoirs, and estimating possible farthest disturbance range/distance of reservoir fracturing simulation;
based on the disturbance range and distance of fracturing simulation of the weak structures in deep geothermal reservoirs for large-scale fracturing, determining well spacing, designing well locations, deploying well patterns and fracturing intervals to complete the design of the large-scale fracturing construction scheme of deep geothermal reservoirs; wherein the step comprises following steps:
step 401, according to spatial distribution range and shape of delineated formation weak structure zones, deploying well locations along a long-axis direction thereof or strike of original weak structural planes;
step 402, according to predicted maximum disturbance range/distance L of reservoir fracturing simulation, determining the well spacing R as follow:
$$R = ( L + L ) \times 80 \%$$
and deploying the well patterns in the entire weak structure zone;
step 403, preferably fracturing intervals according to the burial depth of the weak structure zones at the designed well locations.

2. The method for designing large-scale fracturing construction scheme in deep geothermal reservoirs based on weak structures according to claim 1, in the comprehensive characterizing large models, wherein
the deep geothermal reservoir porosity-permeability evolution model is used to characterize distribution of physical properties characteristics of geothermal reservoirs at laboratory scale;
the deep geothermal reservoir physical property model is used to characterize distribution of physical characteristics of geothermal reservoirs at the laboratory scale;
the model for the evolution of mechanical properties of deep geothermal reservoirs with temperature is used to represent distribution of mechanical characteristics of deep geothermal reservoirs at the laboratory scale;
the wellbore storage geological model is used to represent distribution characteristics of geothermal reservoirs at the wellbore storage scale;
the site-scale three-dimensional geological model of deep geothermal reservoirs is used to analyze and interpret accurate information of formations for large-scale fracturing of deep geothermal reservoirs of different types and scales;
the multi-scale embedded weak structure geological model is used to locate and describe weak structures of different types and scales; and
the rock mechanics constitutive model is used to represent complex weak structure characteristics of deep geothermal reservoirs.

3. The method for designing large-scale fracturing construction scheme in deep geothermal reservoirs based on weak structures according to claim 1, wherein a method for delineation comprises: using the comprehensive characterizing large models to analyze geothermal reservoir parameters, studying a nonlinear evaluation method for deep geothermal reservoirs, evaluating the quality and weakness degree of geothermal reservoirs, and completing delineation of the weak structure zones of the formation for large-scale fracturing of deep geothermal reservoirs.

4. The method for designing large-scale fracturing construction scheme in deep geothermal reservoirs based on weak structures according to claim 1, wherein a method for carrying out fracturability evaluation comprises: establishing a mechanical brittleness index model reflecting whole process characteristics of rock deformation and failure, analyzing brittleness, activation conditions and expansion modes of geothermal reservoir weak structures, and obtaining the fracturability of weak structures in deep geothermal reservoirs for large-scale fracturing formation according to rock brittleness, development characteristics of weak structures and in-situ stress distribution.

5. A system for designing large-scale fracturing construction scheme in deep geothermal reservoirs based on weak structures by the method according to claim 1, comprising a construction module, a delineation module, a prediction module and a design module;
the construction module is used to carry out delineation and characterization of weak structures of formation for large-scale fracturing of deep geothermal reservoirs to obtain the comprehensive characterizing large models;
the delineation module is used to delineate the weak structure zones of the formation for large-scale fracturing of deep geothermal reservoirs and carry out fracturability evaluation based on the comprehensive characterizing large models to obtain the delineated areas;
the prediction module is used to predict the disturbance range and the distance of the fracturing simulation of the weak structures in deep geothermal reservoirs for large-scale fracturing based on the delineated areas; and
the design module is used to determine the well spacing, design the well locations, deploy the well patterns and the fracturing intervals based on the disturbance range and the distance of the fracturing simulation of the weak structures in deep geothermal reservoirs for large-scale fracturing, so as to complete the design of the large-scale fracturing of deep geothermal reservoirs.

6. The system for designing large-scale fracturing construction scheme in deep geothermal reservoirs based on weak structures according to claim 5, wherein the comprehensive characterizing large models comprises the deep geothermal reservoir porosity-permeability evolution model, the deep geothermal reservoir physical property model, the model for the evolution of mechanical properties of deep geothermal reservoirs with temperature, the wellbore storage geological model, the site-scale three-dimensional geological model of deep geothermal reservoirs, the multi-scale embedded weak structure geological model and the rock mechanics constitutive model;
the deep geothermal reservoir porosity-permeability evolution model is used to characterize distribution of physical properties characteristics of geothermal reservoirs at a laboratory scale;
the deep geothermal reservoir physical property model is used to characterize distribution of physical characteristics of geothermal reservoirs at the laboratory scale under high temperature;
the model for the evolution of mechanical properties of deep geothermal reservoirs with temperature is used to characterize distribution of mechanical characteristics of deep geothermal reservoirs at the laboratory scale under high temperature;
the wellbore storage geological model is used to characterize distribution characteristics of geothermal reservoirs at wellbore storage scale;
the site-scale three-dimensional geological model of deep geothermal reservoirs is used to analyze and interpret accurate information of formations for large-scale fracturing of deep geothermal reservoirs of different types and scales;
the multi-scale embedded weak structure geological model is used to locate and describe weak structures of different types and scales; and
the rock mechanics constitutive model is used to characterize complex weak structure characteristics of deep geothermal reservoirs.
